(19) United States
(12) Patent Application Publication
(10) Pub. No.: US 2008/0206725 A1
(43) Pub. Date: Aug. 28, 2008

(54) Candidate Evaluation Tool

(75) Inventors: Shari L. Diaz, Apex, NC (US); Lawrence B. Kroeger, Cary, NC (US); Bradena W. Payne, Frisco, TX (US); Cynthia J. Sullivan, Wappingers Falls, NY (US); Glenn G. Webb, Kyle, TX (US)

Correspondence Address: FREDERICK W. GIBB, III;Gibb & Rahman, LLC, 2568-A RIVA ROAD, SUITE 304, ANNAPOLIS, MD, 21401, US

(73) Assignee: International Business Machines Corporation, Armonk, NY (US)

(21) Appl. No.: 12/054,702

(22) Filed: Mar. 25, 2008

Related U.S. Application Data
(63) Continuation of application No. 11/329,001, filed on Jan. 10, 2006.

(51) Int. Cl. G09B 19/00; G09B 7/00

(52) U.S. Cl. 434/219; 434/362

(57) ABSTRACT

Disclosed are a computer-implemented method and an associated system for use in evaluating candidates interviewed at events, such as job fairs, recruiting events, on-site invitational interviews, etc. Pre-event preparation includes inputting into a first computer system event specific information. During interviews, interviewers are provided with access to this information via remote computers. During post-interview processing, interviewers use this information and the remote computers to determine quantitative interview scores and upload the scores along with qualitative interview feedback to the first computer system. Post-interview processing can also include using the first computer system to systematically rank multiple candidates based on the quantitative interview scores and allowing interested users to view the ranking in real-time. Post-event processing can include allowing users to manually enter another ranking based on the qualitative interview feedback, analyzing all of the compiled data and generating reports based on the analyzed data.

### CROSS-REFERENCE TO RELATED APPLICATIONS

This application is a Continuation of U.S. application Ser. No. 11/329,001 filed Jan. 10, 2006, the complete disclosure of which, in its entirety, is herein incorporated by reference.

### BACKGROUND OF THE INVENTION

1. Field of the Invention

The present invention relates to a candidate evaluation tool. More particularly, the present invention relates to a computer-implemented method and system for evaluating multiple interviewees when each interviewee is interviewed by one or more interviewers.

2. Description of the Related Art

Oftentimes job candidates, prospective students, etc., are interviewed by multiple interviewers at the same event, e.g., a job fair, recruiting event, etc. Typically, following such events, interviewers will compare notes, evaluate and rank the candidates and select the best fit based on both quantitative and qualitative feedback. However, this process can be inefficient and costly. Thus, there is a need in the art for a tool that can improve upon the evaluation process used to select specific candidates from amongst multiple candidates interviewed by multiple interviewers.

### SUMMARY OF THE INVENTION

In view of the foregoing, embodiments of the invention provide a computer-implemented method and a system for evaluating interviewees (i.e., job candidates, prospective students, etc.) that are each interviewed by at least one of a plurality of interviewers, for example, at a job fair or other recruiting-type event.

Embodiments of the computer-implemented method comprise receiving (e.g., into a data storage system of a first computer system) event-specific information. For example, the information can comprise a list of interviewees and background information regarding each interviewee. The information can identify which of the interviewees are to be interviewed by which one or more of the interviewers. More particularly, the information can comprise a list of interviewee groups and corresponding interviewer teams. Each of the interviewee groups can comprise a plurality of interviewees and each of the interviewer teams can comprise a plurality of interviewers. The information can further designate which particular interviewees of a given interviewee group are to be interviewed by which one or more particular interviewers from a corresponding interviewer team. Additionally, the information can comprise type-designations for each interview, weights for each type of interview, predetermined questions for each type of interview, weights for each predetermined question and pre-selected answer values for specific answers to the predetermined questions.

During each interview, an interviewer is provided with access to the above-described information. For example, using a second computer system in communication with the first computer system, the interviewer can access the data storage system in order to determine the type of interview to conduct and the predetermined interview questions that are to be asked. Following each interview, the interviewer can again access the data storage system in order to determine the values that are to be assigned to specific answers provided by the interviewee (i.e., pre-selected answer values) and the weights that are to be assigned to each question. The interviewer can then evaluate the interviewee's answers, determine a quantitative interview score based on the pre-selected answer values and the question weights, and upload the quantitative interview score to the first computer system. The interviewer can also input and upload qualitative interview feedback.

Thus, following each interview, the first computer system receives a quantitative interview score and qualitative interview feedback. If multiple quantitative interview scores are received regarding the same interviewee for the same type of interview, these quantitative interview scores are averaged (e.g., by an average calculator within the first computer system). Then, the received quantitative interview scores for each of the interviewees (including averaged scores, if applicable) are systematically compared to determine a first ranking of the interviewees (e.g., by a comparator within the first computer system). This first ranking is continuously updated following each interview and can be accessed by selected users. As mentioned above, for the purpose of determining the first ranking, different weights can be assigned to different interview types. Thus, two interviewees with the same quantitative interview scores may be ranked differently depending upon the type of interview conducted. Additionally, if for a given event the interviewees have been divided into interviewee groups, a first ranking can first be determined for each group. Then, following the event, the first rankings for each group can be merged (e.g., by a second comparator within the first computer system) into a combined first ranking so as to provide a quantitative assessment of the overall candidate pool.

In addition to determining the first ranking, the first computer system can be adapted to receive a second (user-input) ranking of all of the interviewees based on the qualitative interview feedback associated with each of the interviews. Specifically, interviewers, administrators, and/or managers can collaborate and manually rank the interviewees based on the qualitative interview feedback and input this second ranking into the first computer system to provide a qualitative “good fit” assessment. As with the first ranking, if for a given event the interviewees have been divided into interviewee groups, a second ranking can first be determined for each group. Then, following the event, the second rankings for each of the groups can be merged (e.g., either manually by a user or by the second comparator) into a combined second ranking so as to provide a qualitative assessment of the overall candidate pool.

Lastly, embodiments of the computer-implemented method of the invention can further comprise using a data analyzer to analyze the quantitative interview scores and the qualitative interview feedback and to generate reports based on the analyzed data. The reports may be referred to by decision makers during final candidate selection.

Embodiments of the system of the invention are particularly adapted to facilitate event preparation, to facilitate the interview process and to facilitate the post-interview and post-event analyses. The system comprises a first computer system (i.e., a primary computer system) and a plurality of second computer systems (i.e., secondary or remote computer systems) in communication with said first computer system (e.g., via a wired or wireless network).

The first computer system can comprise a data storage system, an average calculator, at least one comparator, and a data analyzer. Specifically, the first computer system can comprise a data storage system that is adapted to receive and store event specific information. This information can comprise a list of interviewees and background information regarding each interviewee. It can further identify which of the interviewees are to be interviewed by which one or more of the interviewers. More particularly, the information can comprise a list of interviewee groups and corresponding interviewer teams and can designate which particular interviewees of a given interviewee group are to be interviewed by which one or more particular interviewers from a corresponding interviewer team. Additionally, the information can comprise type-designations for each interview, weights for each type of interview, predetermined questions for each type of interview, weights for each predetermined question and pre-selected answer values for specific answers to the predetermined questions. The data storage system can further be adapted to store quantitative interview scores and qualitative interview feedback and any reports generated (e.g., rankings, summaries, etc.) based on this quantitative and qualitative feedback.

The second computer systems can comprise a graphical user interface (GUI) specifically adapted to allow interviewers to access the information in the data storage system, to enter quantitative interview scores following each interview, and to enter qualitative interview feedback following each interview. More specifically, the second computer system can be in communication with the first communication system such that an interviewer can access the data storage system of the first computer system to determine the type of interview to conduct and the predetermined interview questions that are to be asked. Following each interview of an interviewee, the interviewer can again access the data storage system to determine the values that are to be assigned to specific answers provided by the interviewee and the weights that are to be assigned to each question. The GUI can be adapted to allow the interviewer to evaluate the interviewee's answers, determine and input a quantitative interview score based on the pre-selected answer values and the question weights, and upload the quantitative interview score for each interview from the second computer system to the first computer system. The GUI can further be adapted to allow the interviewer to input and upload qualitative interview feedback for each interview.

The first computer system can further be adapted to receive and processes the uploaded quantitative and qualitative interview feedback. Specifically, the first computer system can comprise an average calculator that is adapted to average multiple quantitative interview scores for the same interviewee. The first computer system can further comprise a comparator that is adapted to weight the quantitative interview scores (including averaged scores, if applicable) based on a predetermined weight for the interview type and to systematically compare the weighted quantitative interview scores for each of the interviewees in order to determine a first ranking of the interviewees. Thus, as each interview is completed, the first ranking is updated by the comparator. The data storage device can be adapted to store this ranking such that it is accessible by selected users.

The first computer system can also comprise a second comparator that is adapted to merge multiple first rankings into a combined first ranking. Specifically, if for a given event the interviewees have been divided into interviewee groups, a first ranking can be determined for each group by the first comparator. The second comparator can merge all of the first rankings for each of the groups into a combined first ranking so as to provide a quantitative assessment of the overall candidate pool.

The first computer system can further be adapted to receive a second (user-input) ranking of all of the interviewees based on the qualitative interview feedback associated with each of the interviews in order to provide a qualitative “good fit” assessment. As with the first ranking, if for a given event the interviewees have been divided into interviewee groups, a second ranking can first be determined for each interviewee group. Then, following the event, the second rankings can be merged (e.g., either manually by a user or by the second comparator) into a combined second ranking so as to provide a qualitative assessment of the overall candidate pool.

Lastly, the first computer system can further comprise a data analyzer adapted to analyze both the quantitative interview scores and the qualitative interview feedback and to generate reports based on the analyzed data.

These, and other, aspects and objects of the present invention will be better appreciated and understood when considered in conjunction with the following description and the accompanying drawings. It should be understood, however, that the following description, while indicating embodiments of the present invention and numerous specific details thereof, is given by way of illustration and not of limitation. Many changes and modifications may be made within the scope of the present invention without departing from the spirit thereof, and the invention includes all such modifications.

### BRIEF DESCRIPTION OF THE DRAWINGS

The invention will be better understood from the following detailed description with reference to the drawings, in which:

FIG. 1 is a flow diagram illustrating an embodiment of the computer-implemented method of the invention;

FIG. 2 is a block diagram illustrating an exemplary embodiment of the system of the invention;

FIG. 3 is a graphical user interface screen display that may be used in the implementation of the invention;

FIG. 4 is a graphical user interface screen display that may be used in the implementation of the invention;

FIG. 5 is a graphical user interface screen display that may be used in the implementation of the invention;

FIG. 6 is a graphical user interface screen display that may be used in the implementation of the invention; and

FIG. 7 is a block diagram illustrating a representative hardware environment for practicing the embodiments of the invention.

### DETAILED DESCRIPTION OF EMBODIMENTS OF THE INVENTION

The present invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the present invention. The examples used herein are intended merely to facilitate an understanding of ways in which the invention may be practiced and to further enable those of skill in the art to practice the invention. Accordingly, the examples should not be construed as limiting the scope of the invention.

As mentioned above, there is a need for a candidate evaluation tool that improves upon the current evaluation processes that are used to select specific candidates from amongst multiple candidates interviewed by multiple interviewers. Therefore, disclosed herein is a candidate evaluation tool that allows multiple interviewers, who are assigned to a specific interview type and/or interview group, to compile information during an event such as a job fair, recruiting event, on-site invitational interviews, etc. The tool further can be used to manage information electronically, to compile qualitative feedback from interviewers, and to provide quantitative analysis using a weighted average methodology for ranking candidates. Specifically, the tool allows interviewers to save a candidate's scores and provide comments. The tool also periodically ranks multiple candidates and allows interested users (e.g., administrators) to view the information in real-time.

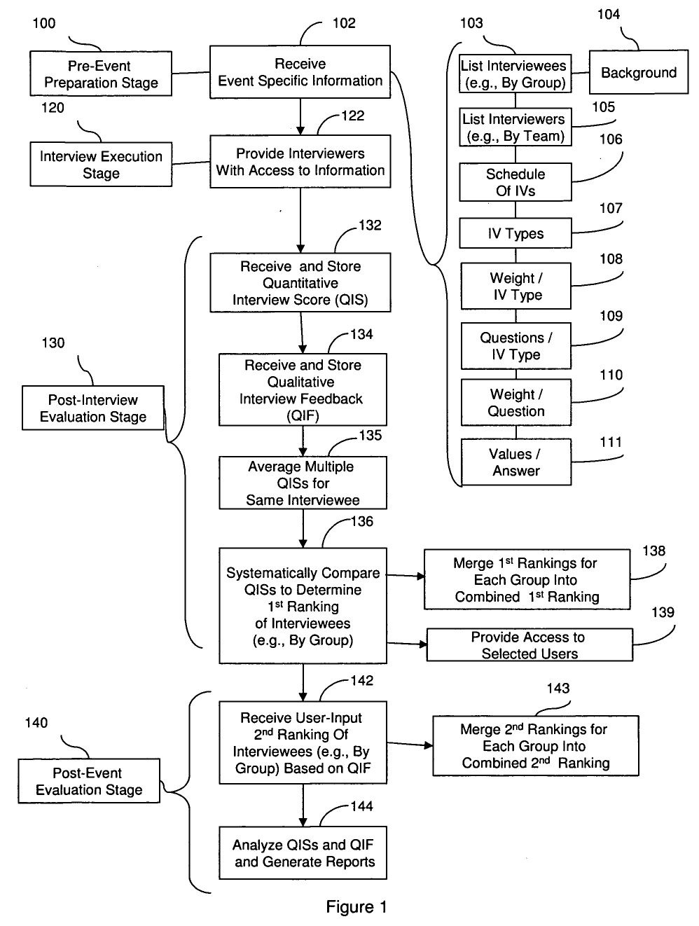

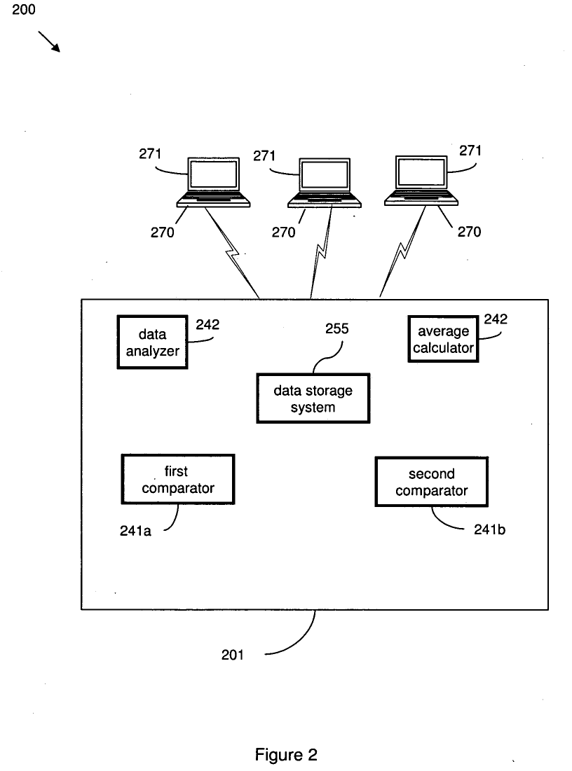

Referring to FIG. 1 in combination with FIG. 2, disclosed are embodiments of a computer-implemented method for evaluating interviewees and, particularly, for evaluating multiple interviewees interviewed by multiple interviewers. The method comprises four process stages: a pre-event preparation stage 100, an interview execution stage 120, a post-interview evaluation stage 130 and a post-event evaluation stage 140.

The pre-event preparation stage 110 comprises receiving (e.g., into the data storage system 255 of the first computer system 201 of the candidate evaluation system 200) event specific information including information that is specific not only to each interviewee (i.e., each candidate) but also to each interview of each interviewee (102). This information can be input into the system 200, for example, by event administrators that are responsible for coordinating all activities for an interview event and/or database administrators that are responsible for managing database information and security. Furthermore, security measures, e.g., clearance levels, can be established to limit access to this information.

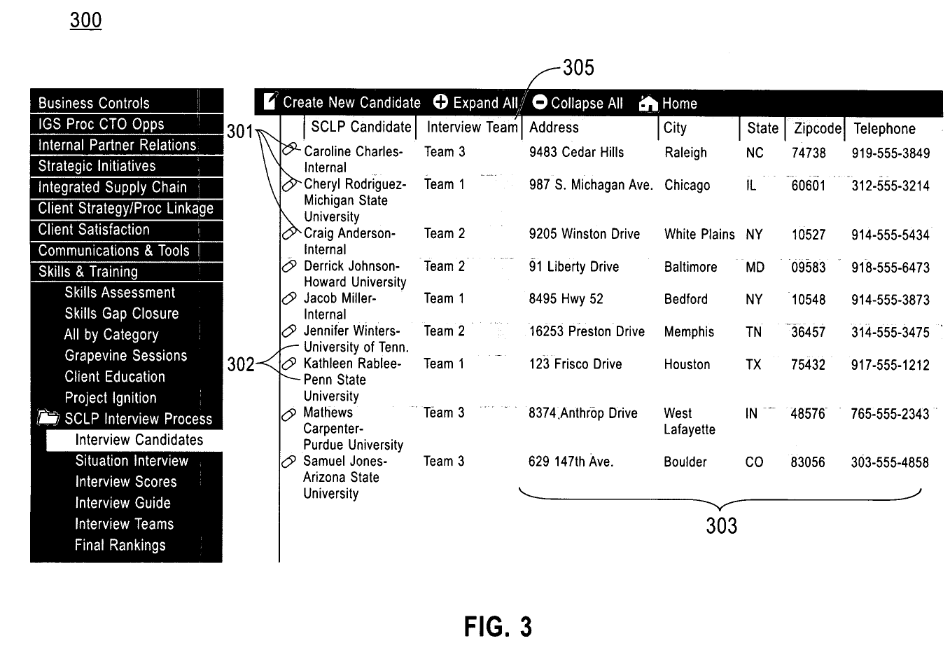

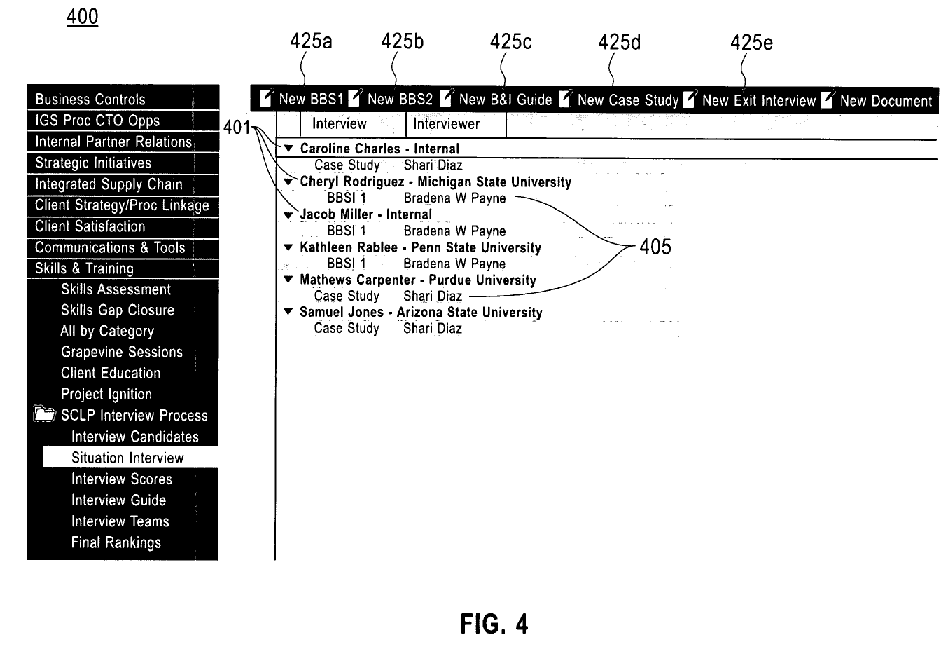

This information can comprise a list of candidates (i.e., interviewees) (103) and background information (104) regarding each interviewee. For example, as illustrated in the exemplary non-limiting GUI screen image 300 of FIG. 3, the information can comprise a complete listing of each candidate's name 301, school 302 and contact information 303 with links to their resumes. This information can also provide a schedule of interviews (106). For example, as illustrated in the exemplary non-limiting GUI screen image 400 of FIG. 4, the schedule of interviews can identify which of the interviewees 401 are to be interviewed by which one or more of the interviewers 405. More particularly, the information can comprise a list of interviewee groups and corresponding interviewer teams. Each of the interviewee groups can comprise a plurality of interviewees and each of the interviewer teams can comprise a plurality of interviewers. The information can further designate which particular interviewees of a given interviewee group are to be interviewed by which one or more particular interviewers from a corresponding interviewer team (e.g., screen image 300 of FIG. 3 further illustrates that interviewees 301 can be assigned to specific interview teams 305).

Additionally, this information can comprise type-designations for each interview (107), weights to be applied to each type of interview (108), predetermined questions for each type of interview (109), weights to be applied to each predetermined question (110) and pre-selected answer values for specific answers to the predetermined questions (111). Thus, the computer-implemented method of the invention provides event administrators with the flexibility to create various interviewing formats and the ability to apply weights to certain questions and/or interview types to emphasize key search criteria. More particularly, because some skills and aptitudes are more important than others when selecting the right candidate for a position, the method allows the event administrator to apply weights to each question behind the scenes. The selected weights will then be used in conjunction with the candidate's scores to compute the candidate's overall ranking during subsequent stages. To ensure consistency among interviewers, it's important that all candidates are asked to respond to a fixed set of questions. However, the same questions are not suitable for all positions. For this reason, the method allows the event administrators to select relevant questions ahead of time and load those questions into the tool (109). For example, as further illustrated in the screen image 400 of FIG. 4, a single event may include multiple interview types (e.g., a Behavioral Based Structured Interview 1 (BBSI 1) 425a, Behavioral Based Structured Interview 2 (BBSI 2) 425b, Background and Interest Interview 425c, Case Study Interview (425d) and an Exit Interview 425e) with different predetermined questions for each type. For a given event, all or some of these interview types may be used when interviewing each of the interviewees.

Referring again to FIG. 1 in combination with FIG. 2, during the execution of each interview (at stage 120), interviewers can be provided with access, subject to security limitations, to the above-described information (122). For example, each interviewer can use a second computer system 270 (e.g., a portable lap top computer comprising the required candidate evaluation tool software and GUI) to access the first computer system 201 (e.g., via a wired or wireless communication network) and, specifically, to access the data storage system 255 of the first computer system 201. This allows the interviewer to determine the type of interview to conduct and the predetermined interview questions that are to be asked. Clearance levels, mentioned above, may limit the access of each interviewer to information regarding candidates to which he or she is assigned or to questions for interview types to which he or she is assigned.

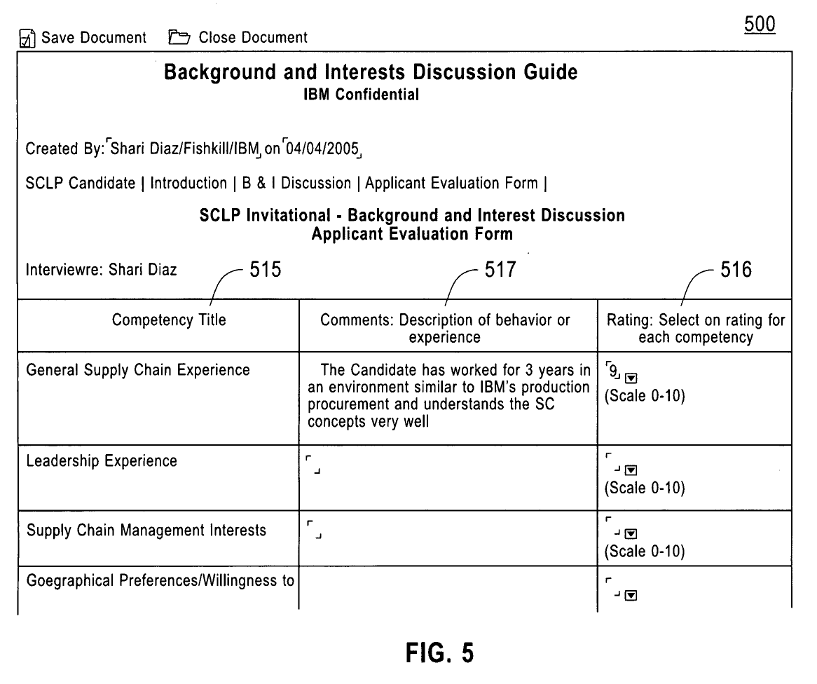

Following each interview of an interviewee, the interviewer can again access the first computer system 201 via the second computer system 270 to determine the values that are to be assigned to specific answers provided by the interviewee (i.e., pre-selected answer values) and the weights that are to be assigned to each question. The interviewer can then evaluate the interviewee's answers, determine and input a quantitative interview score based on the pre-selected answer values and the question weights, and upload the quantitative interview score to the first computer system. The interviewer can also input and upload qualitative interview feedback (e.g., personal reactions to the interviewee and other comments). Thus, the use of the remote computer systems 270 allows the interviewers to enter information into the database 255 themselves capturing feedback quickly and accurately. To capture interviewers' reactions and feedback in their own words, as well as numerical scoring for each candidate on each question asked, the database can offer quick and easy input capabilities to the interviewers themselves (e.g., as illustrated in the exemplary non-limiting screen image 500 of FIG. 5 which provides designated fields 515 for score 516 and comment 517 entries for each question, as well as fields for general comments on each candidate's scorecard). Note that security measures may prevent an interviewer from inputting information into the system regarding any candidate other than those to which he or she is assigned.

Consequently, following each interview of each interviewee (i.e., during the post-interview evaluation stage 130), the first computer system 201 receives a quantitative interview score (132) and qualitative interview feedback (134) from an interviewer. If multiple quantitative interview scores are received regarding the same interviewee for the same type of interview (for example, if the same interviewee is interviewed multiple times by multiple interviewers), the quantitative interview scores for that interviewee are averaged (135) (e.g., by an average calculator 243 within the first computer system 201).

Then, the received quantitative interview scores for each of the interviewees (including averaged scores, if applicable) are systematically compared (e.g., by a comparator 241a within the first computer system 201) to determine a first ranking of the interviewees (136). Because the candidate evaluation process can be subjective, analytical methods are built in this process to ensure the consistent evaluation of all candidates to the same set of standards. As mentioned above, for the purpose of determining the first ranking at process 136, different weights can be assigned to different interview types (i.e., different type-designations). Thus, two interviewees with the same quantitative interview scores may be ranked differently depending upon the type of interview conducted. Additionally, if for a given event (e.g., job fair, recruiting event, etc.) the interviewees have been divided into interviewee groups being interviewed by corresponding interviewee teams, a first ranking can first be determined for the interviewees within each interviewee group. Then, following the event, the first rankings for each of the interviewee groups can be merged (e.g., by a second comparator 241) into a combined first ranking so as to provide a quantitative assessment of the overall candidate pool (138).

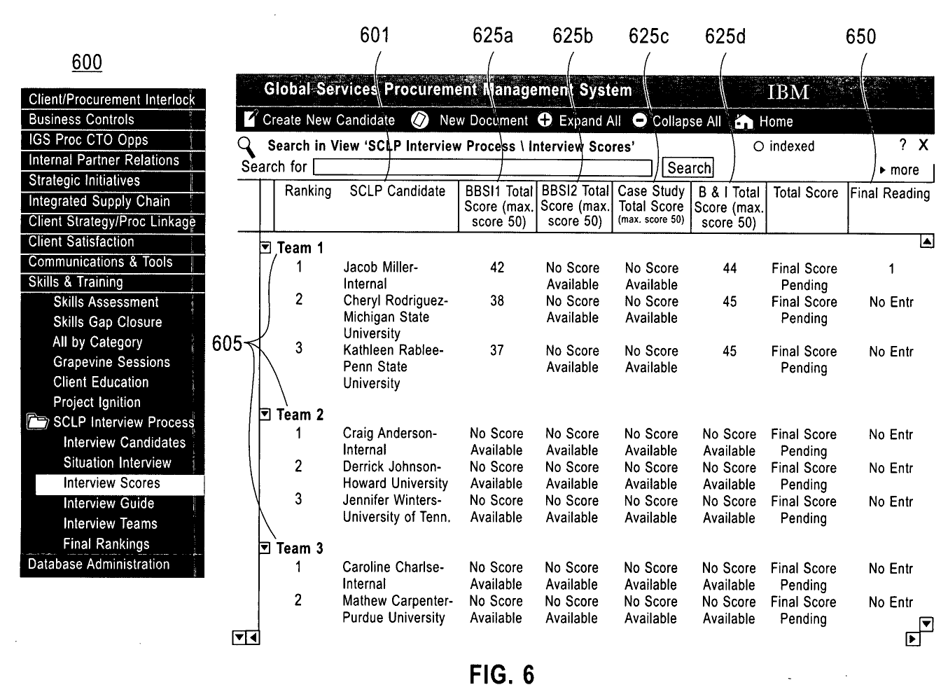

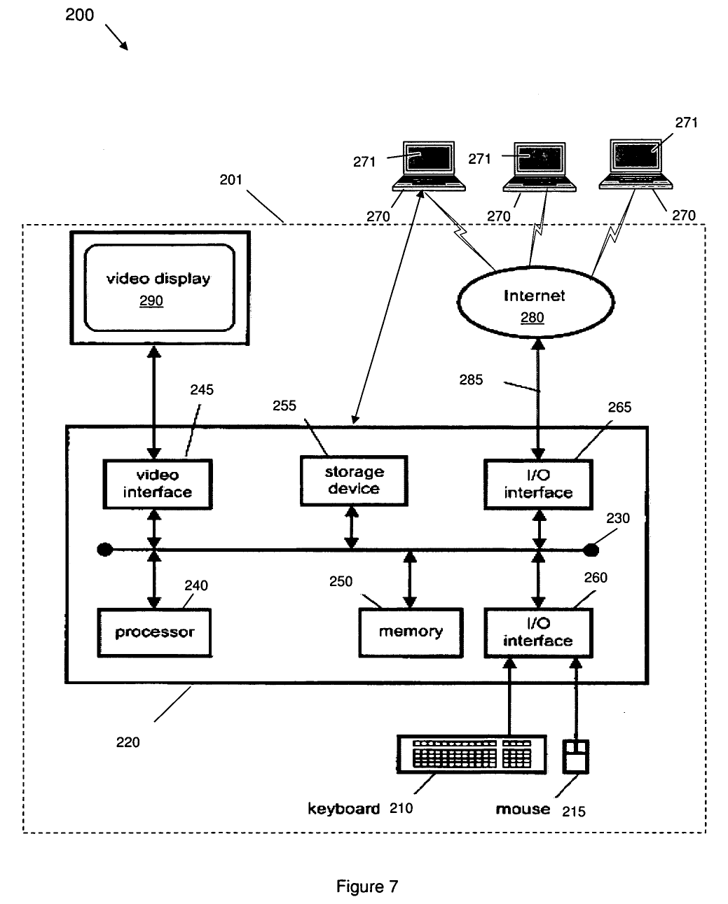

This first ranking is updated as each of the interviews is completed and is accessible, subject to security limitations, by selected users (e.g., managers, administrators, or other users with the appropriate clearance level that are interested in knowing how the candidates compare with one another as the event progresses) (139). For example, as illustrated in screen image 600 of FIG. 6, a selected user can access compiled data in the first computer system 201 (e.g., either indirectly via the GUI 270 of the second computer system 270 or directly via the video display 290 of the first computer system 201 (see FIG. 7)). This allows the user to obtain the current quantitative interview scores of each interviewee 601 for each type of interview 625 and the current ranking 650 of each interviewee 601 within each interviewee group/interviewer team 605. Throughout the course of the event, this data is available in the database real-time. There are no long delays between data entry and data-view capability. Event administrators and interviewers alike can be sure that all information is being captured completely and accurately as events transpire along the way.

In addition to providing a means for comparing the candidates quantitatively, the candidate evaluation tool can also provide a means for comparing the candidates qualitatively. Referring again to FIG. 1 in combination with FIG. 2, during the post-event evaluation (at stage 140), the first computer system 201 can be adapted to receive a second (user-input) ranking of all of the interviewees based on the qualitative interview feedback associated with each of the interviews (142). Specifically, the users (e.g., interviewers, administrators, managers, etc.) can collaborate and manually rank the interviewees based on the qualitative interview feedback and can input this second ranking into the first computer system 201 (e.g., via a second computer system 270, via an input device 210 on the first computer system (see FIG. 7), etc.) in order to provide a qualitative “good fit” assessment of the candidates. As with the first ranking, if for a given event (e.g., job fair, recruiting event, etc.) the interviewees have been divided into interviewee groups being interviewed by corresponding interviewee teams, a second ranking can first be determined for the interviewees within each interviewee group. Then, following the event, the second rankings for each of the interviewee groups can be merged (e.g., either manually by a user or by the second comparator 241b) into a combined second ranking so as to provide a qualitative assessment of the overall candidate pool (143). This feature allows the interviewers or other interested users to rank the candidates numerically without referencing the quantitative interview scores. For example, an interview team can evaluate the corresponding interviewee group by discussing each one with respect to the other, and ranking them qualitatively. These manual rankings can then be incorporated into the subsequently generated reports (at process 144) along with the quantitative rankings to create a balanced perspective.

Embodiments of the computer-implemented method of the invention can further comprise using a data analyzer (see item 242 of FIG. 2) to analyze the quantitative interview scores and the qualitative interview feedback and to generate reports based on the analyzed data (144). For example, the data analyzer 242 can generate summaries of both the quantitative and qualitative feedback on each interviewee, comments summaries, ranked lists by question or interview, etc. These reports can be referenced by decision makers during final candidate selection.

Additional aspects of the computer-implemented method of the invention can include information security and storing and archiving candidate capabilities. For example, the method may be implemented such that interviewers have access to information regarding candidates that they are assigned to interview and all information that they themselves have entered at all times, but only the event administrators have access to the complete set of data at all times. This allows the administrators to ensure that data is being entered properly and avoids lengthy delays due to incomplete or inaccurate entries when summarizing data. Additionally, the method can be implemented using a variety of techniques to export and archive the data collected during the interview process for easy future reference while minimizing the amount of time that the data is resident in the tool itself. These features allow for efficient use of the tool and storage space on the systems, as well as assurance that the data will remain secure at all times.

The computer-implemented method, as described above, can take the form of an entirely hardware embodiment, an entirely software embodiment or an embodiment containing both hardware and software elements. In one embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Referring to FIG. 2, also disclosed are embodiments of a system 200 for use in evaluating interviewees (i.e., job candidates, prospective students, etc.) and, specifically, for use in evaluating interviewees interviewed by multiple different interviewers at an event, such as a job fair, recruiting event, etc. The system 200 of the invention is adapted to facilitate event preparation, to facilitate the interview processes and to facilitate the post-interview and post-event analyses.

More particularly, the candidate evaluation system 200 comprises a first computer system 201 (i.e., a primary computer system) and a plurality of second computer systems 270 (i.e., remote computer systems) in communication with the first computer system 201 (e.g., via a wired or wireless network).

The first computer system 201 can comprise a data storage system 255, an average calculator 243, at least one comparator 241a-b, and a data analyzer 242. Specifically, the first computer system 201 can comprise a data storage system 255 that is adapted to receive and store event specific information, including information that is specific not only to each interviewee but to each interview of each interviewee. This information can comprise a list of interviewees and background information regarding each interviewee (e.g., contact information, education information, a resume, etc.). The information can identify which of the interviewees are to be interviewed by which one or more of the interviewers. More particularly, the information can comprise a list of interviewee groups and corresponding interviewer teams. Each of the interviewee groups can comprise a plurality of interviewees and each of the interviewer teams can comprise a plurality of interviewers. The information can further designate which particular interviewees of a given interviewee group are to be interviewed by which one or more particular interviewers from a corresponding interviewer team. Additionally, the information can comprise type-designations for each interview, weights to be assigned to each type of interview, predetermined questions for each type of interview, weights to be assigned to each predetermined question and pre-selected answer values for specific answers to the predetermined questions. The data storage system 255 can further be adapted to store interview feedback information, including quantitative interview scores and qualitative interview feedback, and any reports generated (e.g., rankings, summaries, etc.) based on that stored information. Access to this information can be subject to security limitations.

The second computer systems 270 can comprise a remote computer system (e.g., portable lap top computer) having a graphical user interface 271 adapted to facilitate implementation of the candidate evaluation tool. The second computer systems 270 can be specifically adapted to allow interviewers to access the information contained in the data storage system 255 of the first computer system 201, to allow interviewers to enter interview feedback information (e.g., quantitative interview scores and qualitative interview feedback) following each interview of each interviewee, and to allow interviewers to upload this interview feedback information to the first computer system 201 following each interview of each interviewee. More specifically, the second computer systems 270 can be adapted to communicate with the first computer system 201 via a wired communication network (e.g., local area network) or wireless communication network (e.g., the internet) so that interviewers can access the data storage system 255 of the first computer system 201, subject to security limitations, in order to determine the type of interview to conduct and the predetermined interview questions that are to be asked. Following each interview of an interviewee, the interviewer can again access the first computer system 201 to determine the values that are to be assigned to specific answers provided by the interviewee (i.e., pre-selected answer values) and the weights that are to be assigned to each question. The interviewer can then evaluate the interviewee's answers, determine a quantitative interview score based on the pre-selected answer values and the question weights, and upload the quantitative interview score from the second computer system 270 to the first computer system 201. The interviewer can also input and upload qualitative interview feedback (e.g., personal reactions to the interviewee and other comments).

The first computer system 201 can further be adapted to receive and processes the uploaded quantitative and qualitative interview feedback. Specifically, first computer system 201 can comprise an average calculator 243 that is adapted to average multiple quantitative interview scores for the same interviewee (e.g., if the same interviewee is interviewed multiple times by multiple interviewers).

The first computer system 201 can further comprise a comparator 241a that is adapted to weight the quantitative interview scores (including averaged scores, if applicable) based on a predetermined weight for the interview type and to systematically compare the weighted quantitative interview scores for each of the interviewees in order to determine a first ranking of the interviewees. The comparator 241a can further be adapted to regularly update the first ranking as the quantitative interview scores for each interview is received. The data storage device 255 can further be adapted to store this updated first ranking so that it is accessible by selected users (e.g., managers, administrators, or other users that may be interested by the progress of the candidates during the event) via the second computer systems 270, via the internet (see item 280 of FIG. 7) or some other output device (e.g., see video display 290 of FIG. 7).

The first computer system 201 can also comprise a second comparator 241b that is adapted to merge multiple first rankings into a combined first ranking. Specifically, if for a given event (e.g., job fair, recruiting event, etc.) the interviewees have been divided into interviewee groups being interviewed by corresponding interviewee teams, first rankings can be determined by the first comparator 241a for the interviewees within each interviewee group. The second comparator 241b can be adapted to merge the first rankings for all or selected interviewee groups into a combined first ranking so as to provide a quantitative assessment of the overall candidate pool. The data storage system 255 can further be adapted to store this combined first ranking so that it is accessible by selected users (e.g., managers, administrators, or other users that may be interested) via the second computer systems 270, via the internet (see item 280 of FIG. 7) or via some other output device (e.g., see video display 290 of FIG. 7).

The first computer system 201 can further be adapted to receive a second (user-input) ranking of all of the interviewees based on the qualitative interview feedback associated with the interviews. Specifically, the users (e.g., interviewers, administrators, managers, etc.) can collaborate and manually rank the interviewees based on the qualitative interview feedback and can input this second ranking into the first computer system 201 (e.g., indirectly via a remote computer system 270, directly via input devices 210, 215 (see FIG. 7), etc.) in order to provide a qualitative “good fit” assessment. As with the first ranking, if for a given event (e.g., job fair, recruiting event, etc.) the interviewees have been divided into interviewee groups being interviewed by corresponding interviewee teams, a second ranking can first be determined for the interviewees within each interviewee group. Then, following the event, the second rankings for each of the interviewee groups can be merged (e.g., either manually by a user or by the second comparator 241b) into a combined second ranking so as to provide a qualitative assessment of the overall candidate pool. The data storage system 255 can further be adapted to store this combined second ranking such that it is accessible to selected users, as discussed above.

Lastly, the first computer system 201 can comprise a data analyzer 242 adapted to analyze both the quantitative interview scores and the qualitative interview feedback and to generate reports based on this data analyses. Such reports can include summaries of the feedback data, ranked lists by question or interview, comments summaries, etc. The data storage system 255 can further be adapted to store these reports so that they are accessible to selected users, as discussed above.

Computer software in both the first computer system 201 and second computer systems 270 execute under a suitable operating system installed to assist in performing the described techniques. This computer software is programmed using any suitable computer programming language, and may be thought of as comprising various software code means for achieving particular steps.

A representative hardware environment for practicing the embodiments of the invention is depicted in FIG. 7. Specifically, the hardware components of the first computer system 201 can comprise a computer 220, a keyboard 210 and a mouse 215, and a video display 290. The computer 220 can also comprise a processor 240, a memory 250, input/output (I/O) interfaces 260, 265, a video interface 245, and the storage device 255. The processor 240 can comprise a central processing unit (CPU) that executes the operating system and the computer software executing under the operating system. The memory 250 can comprise random access memory (RAM) and read-only memory (ROM), and can be used under direction of the processor 240. The video interface 245 can be connected to video display 290. User input to operate the computer 220 can be provided from the keyboard 210 and mouse 215. The storage device 255 can comprise a disk drive or any other suitable storage medium. Each of the components of the computer 220 is connected to an internal bus 230 that includes data, address, and control buses, to allow components of the computer 220 to communicate with each other via the bus 230. The first computer system 201 can be connected to one or more other similar computers (e.g., second computers 270) via input/output (I/O) interface 265 using a communication channel 265 to a network, represented as the Internet 280. The computer software may be recorded on a portable storage medium, in which case, the computer software program is accessed by the first computer system 201 from the storage device 255. Alternatively, the computer software can be accessed directly from the Internet 280 by the computer 220. In either case, a user can interact with the first computer system 201 using the keyboard 210 and mouse 215 to operate the programmed computer software executing on the computer 220. Other configurations or types of computer systems can be equally well used to implement the described techniques. The first computer system 201 described above is described only as an example of a particular type of system suitable for implementing the described techniques. Each of the second computer systems 270 can comprise the same or similar hardware components as those described above with regard to the first computer system 201.

Therefore, disclosed above are a computer-implemented method and an associated system for use in evaluating candidates interviewed at events, such as job fairs, recruiting events, on-site invitational interviews, etc. Pre-event preparation includes inputting into a first computer system event specific information. During interviews, interviewers are provided with access to this information via remote computers. During post-interview processing, interviewers use this information and the remote computers to determine quantitative interview scores and upload the scores along with qualitative interview feedback to the first computer system. Post-interview processing can also include using the first computer system to systematically rank multiple candidates based on the quantitative interview scores and allowing interested users to view the ranking in real-time. Post-event processing can include allowing users to manually enter another ranking based on the qualitative interview feedback, analyzing all of the compiled data and generating reports based on the analyzed data. Thus, the embodiments described above provide a candidate evaluation tool with the flexibility to create various interviewing formats. Additionally, this candidate evaluation tool allows weights to be applied to certain questions/interviews to emphasize key search criteria, applies an analytical methodology to determining quantitative interview scores to ensure consistency among different interviewers and provides for systematic and manual ranking of interviewees. The candidate evaluation tool further provides for real-time or approximately real-time data capture of all interviewer feedback in a paperless environment, for storing and archiving of accumulated data and for automated summary and reports generation.

While the invention has been described in terms of embodiments, those skilled in the art will recognize that the invention can be practiced with modification within the spirit and scope of the appended claims.

What is claimed is:

1. A computer-implemented method of evaluating multiple interviewees that are each interviewed by at least one of multiple interviewers, said computer-implemented method comprising:
receiving from said interviewers a quantitative interview score and qualitative interview feedback following each interview;
systematically comparing quantitative interview scores to determine a first ranking of said interviewees; and
receiving a second ranking of all of said interviewees, wherein said second ranking is user-input and based on said qualitative interview feedback associated with each of said interviews.

2. The computer-implemented method of claim 1, all the limitations of which are incorporated herein by reference, further comprising:
receiving predetermined interview questions for each of said interviews;
receiving pre-selected values to be assigned to specific answers to said predetermined interview questions; and
providing said interviewers with said predetermined questions and said pre-selected values so as to assist said interviewers with said interviews and to allow said interviewers to determine said quantitative interview score for each of said interviews based on said pre-selected values.

3. The computer-implemented method of claim 2, all the limitations of which are incorporated herein by reference, wherein said receiving of said predetermined interview questions comprises receiving first weights to be assigned to said predetermined interview questions for purposes of determining said quantitative interview scores.

4. The computer-implemented method of claim 1, all the limitations of which are incorporated herein by reference, further comprising receiving type-designations for said interviews and receiving different predetermined interview questions depending upon said type-designations.

5. The computer-implemented method of claim 4, all the limitations of which are incorporated herein by reference, further comprising receiving second weights to be assigned to said type-designations for purposes of determining said first ranking.

6. The computer-implemented method of claim 1, all the limitations of which are incorporated herein by reference, further comprising storing event specific information and providing said interviewers with access to said event specific information during said interviews.

7. The computer-implemented method of claim 1, all the limitations of which are incorporated herein by reference, further comprising before determining said first ranking, averaging said quantitative interview scores that are received from multiple interviewers of a same interviewee.

8. A computer-implemented method of evaluating groups of interviewees that are interviewed by corresponding teams of interviewers, said computer-implemented method comprising:
receiving a list of interviewee groups and corresponding interviewer teams, wherein each of said interviewee groups comprises multiple interviewees, wherein each of said interviewer teams comprises multiple interviewers, and wherein each interviewee of a given interviewee group is to be interviewed by at least one interviewer from a corresponding interviewer team;
receiving from said interviewers a quantitative interview score and qualitative interview feedback following each interview;
systematically comparing quantitative interview scores to determine a first ranking of said interviewees within each of said interviewee groups;
receiving a second ranking of said interviewees within each of said interviewee groups, wherein said second ranking is user-input and based on said qualitative interview feedback; and
merging said first ranking for each of said interviewee groups into a combined first ranking and merging said second ranking for each of said interviewee groups into a combined second ranking.

9. The computer-implemented method of claim 9, all the limitations of which are incorporated herein by reference, further comprising:
receiving predetermined interview questions for each of said interviews;
receiving pre-selected values to be assigned to specific answers to said predetermined interview questions; and
providing said interviewers with said predetermined questions and said pre-selected values so as to assist said interviewers with said interviews and to allow said interviewers to determine said quantitative interview score for each of said interviews based on said pre-selected values.

10. The computer-implemented method of claim 10, all the limitations of which are incorporated herein by reference, wherein said receiving of said predetermined interview questions comprises receiving first weights to be assigned to said predetermined interview questions for purposes of determining said quantitative interview scores.

11. The computer-implemented method of claim 9, all the limitations of which are incorporated herein by reference, further comprising receiving type-designations for said interviews and receiving different predetermined interview questions depending upon said type-designations.

12. The computer-implemented method of claim 12, all the limitations of which are incorporated herein by reference, further comprising receiving second weights to be assigned to said type-designations for purposes of determining said first rankings.

13. The computer-implemented method of claim 9, all the limitations of which are incorporated herein by reference, further comprising storing event specific information and providing said interviewers with access to said event specific information during said interviews.

14. A system for evaluating multiple interviewees that are each interviewed by at least one of a multiple interviewers at an event, said system comprising:
a first computer system comprising a comparator and a data storage system, wherein said data storage system is adapted to receive and store information; and
a plurality of second computer systems in communication with said first computer system,
wherein said second computer systems are each adapted to allow interviewers to access said information and to enter a quantitative interview score and qualitative interview feedback following each interview,
wherein said comparator is adapted to systematically compare said quantitative interview scores to determine a first ranking of all of said interviewees, and
wherein said first computer system is further adapted to receive a second user-input ranking of all of said interviewees based on said qualitative interview feedback.

15. The system of claim 17, all the limitations of which are incorporated herein by reference, wherein said information comprises predetermined interview questions and pre-selected values to be assigned to specific answers to said predetermined interview questions when determining said quantitative interview scores.

16. The system of claim 18, all the limitations of which are incorporated herein by reference, wherein said information further comprises first weights to be assigned to said predetermined interview questions for purposes of determining said quantitative interview scores.

17. The system of claim 17, all the limitations of which are incorporated herein by reference, wherein said information further comprises type-designations for each of said interviews and different predetermined interview questions for each of said type-designations.

18. The system of claim 20, all the limitations of which are incorporated herein by reference, wherein said information further comprises second weights to be assigned to each of said type-designations for purposes of determining said first ranking.

19. The system of claim 17, all the limitations of which are incorporated herein by reference, wherein said first computer system further comprises an average calculator adapted to average said quantitative interview scores that are received from multiple interviewers of a same interviewee before said comparator determines said first ranking.

20. A computer program product device readable by computer and tangibly embodying a program of instructions executable by said computer to perform a method of evaluating a multiple interviewees that are each interviewed by at least one of multiple interviewers, said method comprising:
receiving from said interviewers a quantitative interview score and qualitative interview feedback following each interview;
systematically comparing quantitative interview scores to determine a first ranking of said interviewees; and
receiving a second ranking of all of said interviewees, wherein said second ranking is user-input and based on said qualitative interview feedback associated with each of said interviews.
